(19) United States
(12) Patent Application Publication
(10) Pub. No.: US 2025/0069786 A1
(43) Pub. Date: Feb. 27, 2025

(54) COMPOSITE MATERIAL FOR PREPARING DUPLEX-WINDING COUPLING INDUCTOR, DUPLEX-WINDING COUPLING INDUCTOR AND PREPARATION METHOD OF DUPLEX-WINDING COUPLING INDUCTOR

(71) Applicant: ZHONGSHAN SKCOIL ELECTRONIC CO., LTD, Zhongshan City (CN)

(72) Inventor: Liang-Jun QIN, Zhongshan City (CN)

(21) Appl. No.: 18/810,876

(22) Filed: Aug. 21, 2024

(30) Foreign Application Priority Data
Aug. 22, 2023 (CN) 202311064662.0

(51) Int. Cl. H01F 1/147; H01F 17/04; H01F 27/28; H01F 41/02; H01F 41/04

(52) U.S. Cl. CPC H01F 1/14741; H01F 17/04; H01F 27/2852; H01F 41/0246; H01F 41/04

(57) ABSTRACT

A composite material for preparing a duplex-winding coupling indictor, in mass percentage, is composed of: 70% to 75% of iron-nickel-molybdenum powders, 20% to 25% of amorphous powders, 2% to 5% of epoxy resin, 0.3% to 0.5% of coupling agent, and 0.1% to 1.5% of zinc stearate accordingly, a composite material for preparing a duplex-winding coupling indictor is provided.

### CROSS-REFERENCE TO RELATED APPLICATIONS

This application is based upon and claims priority under 35 U.S.C. 119 from China Patent Application No. 202311064662.0 filed on Aug. 22, 2023, which is hereby specifically incorporated herein by this reference thereto.

### BACKGROUND OF THE INVENTION

### 1. Field of the Invention

The present invention relates to an inductor, and more particularly to a composite material for preparing a duplex-winding coupling indictor, a duplex-winding coupling indictor, and a preparation method for the same.

### 2. Description of the Prior Arts

An inductor can be applied to transform electrical energy into magnetic energy and store the magnetic energy. The inductor has an inductance to block the change of current. If the current does not pass through the inductor, the inductor will try to stop the current passing through the inductor when the circuit is connected. If the current pass through the inductor, the inductor will keep the current to pass through the inductor when the circuit is disconnected.

Nearly, with the improvements of artificial intelligence, calculation of big data, cloud server, and autonomous vehicle, strict requirements are requested in the performance of hardware equipment, particularly to demand to local power to be bigger and bigger. However, in general, the voltage applied into An IC is designed to be lower and lower to fit with the power demand. To increase the current is the only option for circuit design. On the other hand, taking an electrical equipment, such as vehicle 50 communication module or AI server as an example. Considering the particularity of the application of location of the electrical equipment, when conceiving and designing the product of the inductor, strict requirements are requested to outer size or internal components of the inductor. Not only considering the full use of the internal space of the equipment, and the closely arrangement of kinds of electric components inside the equipment to reduce the size of the inductor, corresponding performance demand but also be considered.

At present, a kind of inductor, a duplex-winding coupling indictor, is widely applied to a distribution system or an electronic circuit, such as CN 219017406U, China utility model shows a regular structure of a duplex-winding coupling indictor. Two magnetic bodies of the conventional duplex-winding coupling indictor are mirrored to each other and are bonded with each other by glue. Thus, the magnetic bodies cannot be bonded closely with each other, such that the inductance of the convention inductor is unstable. The saturation current of the inductor is lowered, loss of the inductor becomes higher, and the conventional inductor cannot fit with the performance demand. In addition the magnetic body of the convention inductor has to be made by sintering, such that the cost for manufacturing the convention inductor is high.

With the formula and art system of China invention patent with issue number CN116313347A with a title “Composite Material For Preparing An Inductor, Inductor, Method for Preparing For The Same”, a magnetic body is manufactured by a cold pressing process. After the magnetic body is combined with a coil, an inductor is made by a hot pressing process. The conventional inductor can solve the problem of low saturation current of the inductor, but the performance for withstanding voltage of the inductor is lowered. When eight inductors are connected with each other in series, an instant working voltage of the inductors achieves 96V. Therefore, the inductors are easily breakdown.

To overcome the shortcomings, the present invention provides an inductor to mitigate or to obviate the aforementioned problems.

### SUMMARY

In according to the technology problem of the conventional inductor, the objective of the present invention is to provide a composite material for preparing a duplex-winding coupling indictor, a duplex-winding coupling indictor made of the composite material has an excellent performance.

To achieve the aforementioned objective, the present invention provides a composite material for preparing a duplex-winding coupling indictor, in mass percentage, composed of:
70% to 75% of iron-nickel-molybdenum powders;
20% to 25% of amorphous powders;
2% to 5% of epoxy resin;
0.3% to 0.5% of coupling agent; and
0.1% to 1.5% of zinc stearate.

The present invention also provides a preparation method for a duplex-winding coupling inductor comprising steps as follows:
S1: making coils: an outer coil being gained by pressing process, an inner coil being gained by a bending process, the outer coil being U-shaped with two ends bent outward to be served as leads of the outer coil, and the inner coil being C-shaped with two ends bent inward to be served as leads of the inner coil;
S2: making magnetic body: making an E core and an I core by the composite material as claimed in claim 1, and comprising steps of:
adding the epoxy resin and the coupling agent into a solvent to gain a first mixer, adding the iron-nickel-molybdenum powders and the amorphous powders into the first mixer and mixing evenly to gain a second mixer, granulating the second mixer into particles, adding the zinc stearate into the particles and mixing evenly to gain a third mixer, putting the third mixer into molds to form the E core and the I core by cold pressing processes, wherein the E core has a holding recess for holding the outer coil and the inner coil inside and a block on a side of the E core, the I core has a cavity for holding the block on the E core, and a notch is defined in a bottom of the E core communicating with the holding recess;
S3: assembling: putting the outer coil and the inner coil made in S1 into the holding recess in the E core to make the leads of the outer coil and the inner coil be exposed from the notch in the E core, and engaging the block on the E core with the cavity in the I core;
S4: hot pressing: hot pressing the assembled E core, the outer coil, the inner coil, and the I core to form a formed element;
D5: baking: baking the formed element;
D6: rolling spray and peeling paint: rolling spray and peeling paint the baked formed element to gain an inductor;
D7: surface treatment: locations on a surface of the inductor with being peeled paint and two sides of the inductor being adjacent to the leads of the outer coil being respectively plated with a composite layer, wherein the composite layer comprises a copper layer, a nickel layer, and a tin layer from outside to inside and a duplex-winding coupling inductor is gained.

With the aforementioned features, with the magnetic bodies made of the specific composite material in accordance with the present invention and the duplex-winding coupling made by the specific method in accordance with the present invention, the duplex-winding coupling has excellent induction performance. With the specific composite material and the specific cold pressing, the specific E core and the I core are made first, the outer coil and the inner coil are put into the holding recess in the E core. The block on the E core is inserted into the cavity in the I core. With the specific hot pressing, a formed element is gained to effectively solve the unstable induction, low saturation current, high loss problems of the conventional duplex-winding couplings. The duplex-winding coupling inductor in accordance with the present invention can be combined tightly and has a stable induction, high saturation current, low loss, and high voltage withstanding. In addition, with baking process (staged baking), the splitting risk on the inductor can be reduce, and thermal expansion problem to the inductor due to high temperature solidification at high speed can be prevented.

### BRIEF DESCRIPTION OF THE DRAWINGS

FIG. 1 is a bottom perspective view of an embodiment of a duplex-winding coupling inductor in accordance with the present invention;

FIG. 2 is an exploded perspective view of the duplex-winding coupling inductor in FIG. 1;

FIG. 3 is another exploded perspective view of the duplex-winding coupling inductor in FIG. 1;

FIG. 4 is a cross sectional side view of the duplex-winding coupling inductor in FIG. 1;

FIG. 5 is a perspective view of the duplex-winding coupling inductor in FIG. 1 with surface treatment; and

FIG. 6 is an exploded perspective view of a comparison embodiment 6 of a duplex-winding coupling inductor in accordance with the present invention.

### DETAILED DESCRIPTION OF THE EMBODIMENTS

Other objectives, advantages and novel features of the invention will become more apparent from the following detailed description when taken in conjunction with the accompanying drawings.

In the following examples and embodiments, the epoxy resin is the epoxy resin with a model NF552 produced by YONG KANG CO., Ltd.

The coupling agent is alkane coupling agent and is a silane coupling agent with a model KH-550 produced by NANJING JINGTIANWEI CHEMICAL CO., Ltd.

The zinc stearate is produced by SAINUOTECH CO., Ltd.

The iron-nickel-molybdenum powders are MMP product produced by AT&M CO., Ltd.

The amorphous powders are AP07 product produced by AT&M CO., Ltd.

The iron-silicon-chromium powders are iron-silicon-chromium-D produced by AT&M CO., Ltd.

The hydroxyl iron powders are RTE produced by TIAN YI CO., Ltd.

The size of the coil in the following examples and embodiments are the same, the inductor has only one size, the length-height-width of the inductor is 11.2 mm×7.3 mm×6.0 mm.

### Example 1

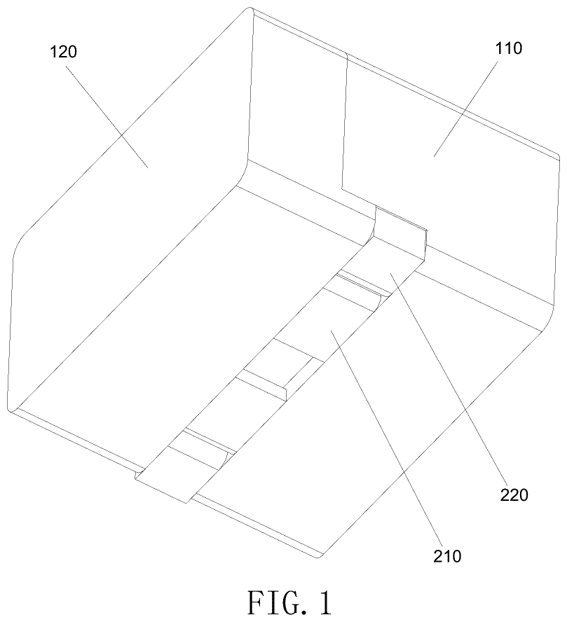

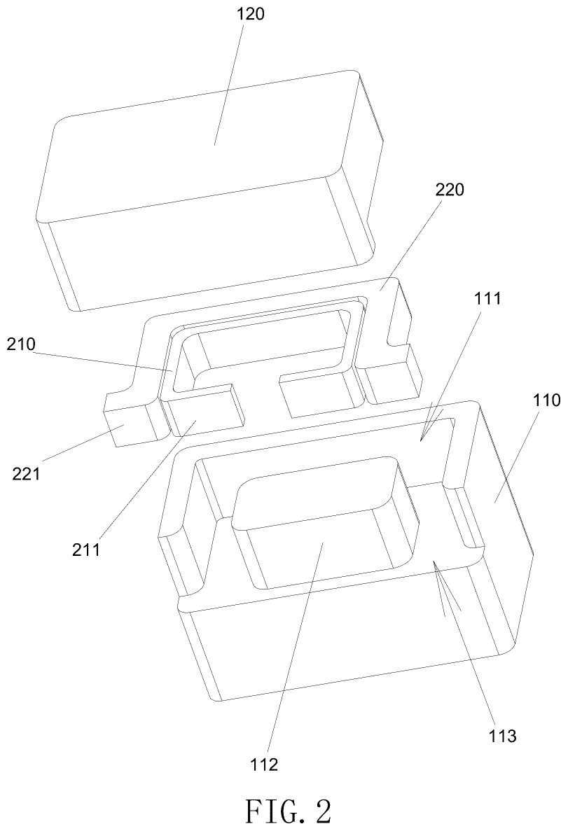

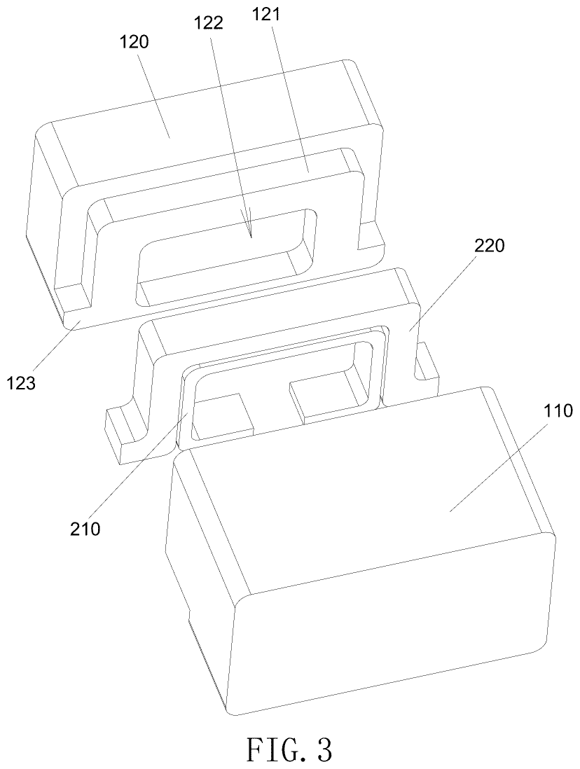

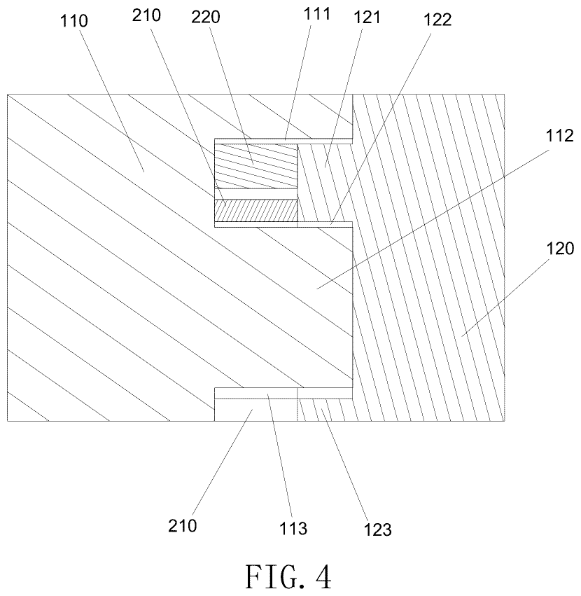

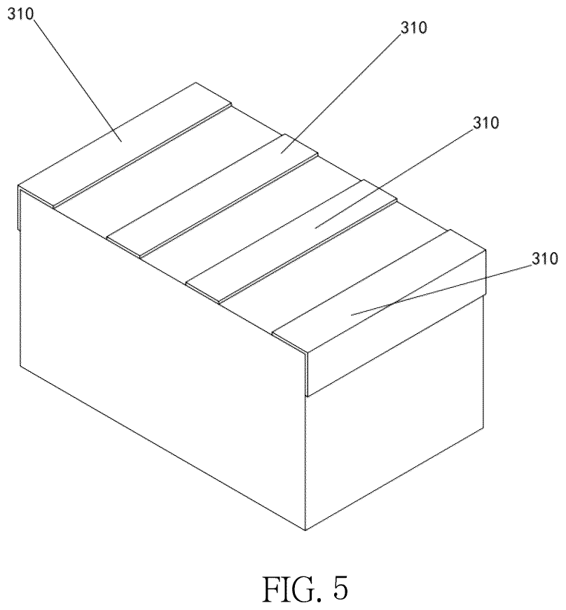

With reference to FIGS. 1 to 5, a preparation method for a duplex-winding coupling inductor in accordance with the present invention comprises steps as follows:
S1: making coils: An outer coil 220 is gained by a pressing process. An inner coil 210 is gained by a bending process. In practice, the outer coil 220 is made by a copper plate being pressed. The outer coil 220 is U-shaped with two ends bent outward to be served as leads 221 of the outer coil 220. The inner coil 210 is C-shaped with two ends bent inward to be served as leads 211 of the inner coil 210.
S2: making magnetic body: An E core 110 and an I core 120 are made of a composite material, in mass percentage, composed of:
70% of iron-nickel-molybdenum powders;
25% of amorphous powders;
4% of epoxy resin;
0.3% of coupling agent; and
0.7% of zinc stearate.

Wherein, the iron-nickel-molybdenum powders are composed of 10% of nickel, 10% of molybdenum, and the others are iron.

The processes for making the E core 110 and the I core 120 comprises the following steps:

The epoxy resin and the coupling agent are added into a solvent to gain a first mixer. The iron-nickel-molybdenum powders and the amorphous powders are added into the first mixer and are mixed evenly to make ethanol volatilize to gain a second mixer in a colloidal type. The second mixer is put into a granulator with a sieve having 100 meshes to granulate the second mixer into particles. The second mixer are baked under 45° C. for 2 hours and then sieved (a sieved with 100 meshes). The sieved particles are added with the zinc stearate and are then stirred at 100 r/min rotation speed for 0.5 hour to be mixed evenly and to gain a third mixer. The third mixed is put into molds. With cold processes, the E core 110 and the I core 120 are formed. The E core 110 has a holding recess 111 and a block 112 formed on a side of the E core 110. The shape and the size of the holding recess 111 correspond to the shape and size of a combination of the outer coil 220 and the inner coil 210. The outer coil 220 and the inner coil 210 are held in the holding recess 111, and the outer coil 220 is arranged around the inner coil 210. The I core 120 has a cavity 122 for holding the block 112 on the E core 110. A notch 113 is defined in a bottom of the E core 110 and communicates with the holding recess 111. Wherein, a pressure for the cold pressing is 3.5 T/cm², and a time for the cold pressing is 2 seconds. The amount of the added solvent is equal to 25% of the amount of the epoxy resin, the silane coupling agent, the iron-nickel-molybdenum powders, and the amorphous powders.
S3: assembling: The outer coil 220 and the inner coil in S1 are put in the holding recess 111 of the E core 110 to make the leads 211, 221 of the outer coil 220 and the inner coil 210 be exposed from the notch 113 in the E core 110. The block 112 on the E core 110 is inserted into and engaged with the cavity 122 in the I core 120. Accordingly, the shape of the inductor is neat and the performance of the inductor is enhanced.
S4: hot pressing: The assembled E core 110, the outer coil 220, the inner coil 210, and the I core 120 is proceeded with a hot pressing process to form a formed element. The temperature for the hot pressing is 180° C., the pressure for the hot pressing is 5.5/cm², and the time for the hot pressing is 50 seconds.
D5: baking: The formed element is put into an oven, is gradiently temperature-increasing baked and is then gradiently temperature-decreasing baked. In practice,
a first section: temperature for baking being 80° C. and time for baking being 30 minutes;
a second section: temperature for baking being 100° C. and time for baking being 30 minutes;
a third section: temperature for baking being 120° C. and time for baking being 30 minutes;
a fourth section: temperature for baking being 140° C. and time for baking being 30 minutes;
a fifth section: temperature for baking being 180° C. and time for baking being 120 minutes;
a sixth section: temperature for baking being 140° C. and time for baking being 15 minutes;
a seventh section: temperature for baking being 120° C. and time for baking being 15 minutes; and
an eighth section: temperature for baking being 100° C. and time for baking being 15 minutes.
D6: rolling spray and peeling paint: the formed element is proceeded with rolling spray and peeling paint to gain an inductor. In the rolling spray, insulating paint is evenly coated on to the surface of the inductor. In the peeling paint, the paint on the portion on the leads 221, 211 of the outer coil 220 and the inner coil 210 exposed from the formed element are peeled off to make the copper plate and the copper wire be exposed from the surface of the inductor.
D7: surface treatment: Locations on the surface of the inductor with being peeled paint and two sides of the inductor being adjacent to the leads 221 of the outer coil 220 are respectively plated with a composite layer. The composite layer comprises a copper layer, a nickel layer, and a tin layer from outside to inside and a duplex-winding coupling inductor is gained. Wherein, the thickness of the copper layer is 3 μm, the thickness of the nickel layer is 2 μm, and the thickness of the tin layer is 7 μm. A side surface of the inductor plated with the composite layer is on a top surface to a position at ⅙ of a side surface of the leads 221 of the outer coil 220.

With reference to FIGS. 1 to 5, the duplex-winding coupling inductor in accordance with the present invention comprises the E core 110, the I core 120, the inner coil 210, and the outer coil 220.

The E core 110 and the I core 120 are made of magnetic powders by a pressing process, actually by a cold pressing. The shape of the cores 110, 120 are cuboids. The holding recess 111 and the block 112 are formed on the side of the E core 110. The shape and the size of the holding recess 111 correspond to the shape and the size of the combination of the inner coil 210 and the outer coil 220, such that the inner coil 210 and the outer coil 220 are embedded into the holding recess 110. The outer coil 220 is arranged around the inner coil 210. The inner coil 210 is made of flat copper wire with a polyurethane insulating layer coated around the outer surface of the wire bent three times to form a C-shape. Two ends of the wire are bent inward to be severed as the leads 211 of the inner coil 210. The outer coil 220 is made of a flat copper plate is proceeded with a pressing process to form a U-shape. Two ends of the plate are bent outward to be severed as the leads 221 of the outer coil 220.

A cavity 122 is defined in a side of the I core 120. The shape and size of the cavity 122 correspond to the shape and size of the block 112. When assembling the duplex-winding coupling indictor, the inner coil 210 and the outer coil can be put into the holding recess 11 first, the block 112 is then inserted into the cavity 122 to make the E core 110 and the I core 120 can be assembled with each other precisely. Accordingly, after assembling, the appearance of the inductor is neat, the performance of the inductor is enhanced. Finally, the E core 110 and the I core 120 is combined with each other with a hot pressing process and is integrally connected with each other without any gap between the E core 110 and the I core 120. Thus, the cores 110, 120 are tightly integrated with each other, such that the inductance value of the inductor is stable.

The holding recess 111 is arranged around the block 12. A U-shaped protrusion is formed on the side of the E core 110, and the holding recess 111 is formed between the protrusion and the block 112 to make the block 112 be located inside the holding recess 111. Accordingly, the structure of the E core is compact so as to reduce the space for the E core 110, and the volume of the magnetic body can be reduced and the performance of the inductor can be kept from being badly influenced.

A plug block 121 is formed and protruding from a side of the I core 120. The cavity 122 is defined in an inner surface of the plug block 121. A thickness of the inner coil 210 and a thickness of the outer coil 220 are all smaller than a depth of the holding recess 111. Thus, a space still exists in the holding recess 111 after the coils 210, 220 being put into the holding recess 111. The plug block 121 is plugged into the holding recess. According, an engagement structure is formed between the E core 110 and the I core 120, the combination tightness between the cores 110, 120 can be enhanced and the induction value of the inductor is stable.

A notch 113 is defined in the bottom of the E core 110 and communicates with the holding recess 111. The leads 211, 221 of the inner coil 210 and the outer coil 220 are exposed from the notch 113 in the E core 110 to form as lead legs. Thus, the inductor can be electrically with an outer circuit with the lead leg by soldering.

The leads 211, 221 of the inner coil 210 and the outer coil 220 exposed from the E core 110 are plated with a composite layer 310. The two sides of the inductor being adjacent to the leads 221 of the outer coil 220 are also plated with a composite layer 310. The composite layer 310 comprises a copper layer, a nickel layer, and a tin layer from outside to inside. The other portions of the inductor are coated with an insulation paint layer.

The plug block 121 further comprises a block portion 123 formed on a bottom of the plug block 121. The block portion 123 is inserted into the notch 113. During the hot pressing, the block portion can fill the notch 113.

The thickness of the E core 110 is larger than the thickness of the I core 120. The holding recess 111 and the block 112 are arranged in the E core 110, such that the thickness of the E core 110 is thick, such that the E core 110 has an enough space for arranging the holding recess 111 and the block 112.

### Example 2

As shown in Table one, comparing to the example 1, difference between the example 2 and the example 1 is
S2: The E core 110 and the I core 120 are made of a composite material. The composite material, in mass percentage, composed of:
75% of iron-nickel-molybdenum powders;
20% of amorphous powders;
4% of epoxy resin;
0.3% of coupling agent; and
0.7% of zinc stearate.

Wherein, the iron-nickel-molybdenum powders are composed of 10% of nickel, 11% of molybdenum, and the others are iron.

Wherein the amorphous powders are composed of:
3.0% of Si (Silicon);
4% of B (Boron);
1.0% of C (Carbon);
0.03% of P (Phosphorus);
0.01% of S (Sulfur), and the others are iron.

The structure of the duplex-winding coupling indictor in example is same as that in the example 1.

### Example 3

As shown in Table one, comparing to the example 1, difference between the example 3 and the example 1 is
S2: The E core 110 and the I core 120 are made of a composite material. The composite material, in mass percentage, composed of:
73% of iron-nickel-molybdenum powders;
23% of amorphous powders;
3% of epoxy resin;
0.3% of coupling agent; and
0.7% of zinc stearate.

Wherein, the iron-nickel-molybdenum powders are composed of 10% of nickel, 10% of molybdenum, and the others are iron.

Wherein the amorphous powders are composed of:
3.0% of Si;
4% of B;
1.0% of C;
0.03% of P;
0.01% of S, and the others are iron.

The structure of the duplex-winding coupling indictor in example is same as that in the example 1.

### Comparison Embodiment 1

As shown in Table one, comparing to the example 1, difference between the comparison embodiment 1 and the example 1 is in the material ratio of the composite material in step S2:
S2: The E core 110 and the I core 120 are made of a composite material. The composite material, in mass percentage, composed of:
80% of iron-nickel-molybdenum powders;
16% of amorphous powders;
3% of epoxy resin;
0.3% of coupling agent; and
0.7% of zinc stearate.

Wherein, the iron-nickel-molybdenum powders are composed of 10% of nickel, 10% of molybdenum, and the others are iron.

Wherein the amorphous powders are composed of:
3.0% of Si;
4.0% of B;
1.0% of C;
0.03% of P;
0.01% of S, and the others are iron.

The structure of the duplex-winding coupling indictor in the embodiment is same as that in the example 1.

### Comparison Embodiment 2

As shown in Table one, comparing to the example 1, difference between the comparison embodiment 2 and the example 1 is in the material ratio of the composite material in step S2:
S2: The E core 110 and the I core 120 are made of a composite material. The composite material, in mass percentage, composed of:
85% of iron-nickel-molybdenum powders;
11% of amorphous powders;
3% of epoxy resin;
0.3% of coupling agent; and
0.7% of zinc stearate.

Wherein, the iron-nickel-molybdenum powders are composed of 10% of nickel, 10% of molybdenum, and the others are iron.

Wherein the amorphous powders are composed of:
3.0% of Si;
4.0% of B;
1.0% of C;
0.03% of P;
0.01% of S, and the others are iron.

The structure of the duplex-winding coupling indictor in the embodiment is same as that in the example 1.

### Comparison Embodiment 3

As shown in Table one, comparing to the example 1, difference between the comparison embodiment 3 and the example 1 is in the material ratio of the composite material in step S2:
S2: The E core 110 and the I core 120 are made of a composite material. The composite material, in mass percentage, composed of:
75% of iron-silicon-chromium powders;
20% of amorphous powders;
4% of epoxy resin;
0.3% of coupling agent; and
0.7% of zinc stearate.

Wherein, the iron-silicon-chromium powders are composed of 4.9% of silicon, 5.5% of chromium, and the others are iron.

Wherein the amorphous powders are composed of:
3.0% of Si;
4.0% of B;
1.0% of C;
0.03% of P;
0.01% of S, and the others are iron.

The structure of the duplex-winding coupling indictor in the embodiment is same as that in the example 1.

### Comparison Embodiment 4

As shown in Table one, comparing to the example 1, difference between the comparison embodiment 4 and the example 1 is in the material ratio of the composite material in step S2:
S2: The E core 110 and the I core 120 are made of a composite material. The composite material, in mass percentage, composed of:
75% of carbonyl iron powders;
20% of amorphous powders;
4% of epoxy resin;
0.3% of coupling agent; and
0.7% of zinc stearate.

Wherein the amorphous powders are composed of:
3.0% of Si;
4.0% of B;
1.0% of C;
0.03% of P;
0.01% of S.

The structure of the duplex-winding coupling indictor in the embodiment is same as that in the example 1.

### Comparison Embodiment 5

As shown in Table one, comparing to the example 1, difference between the comparison embodiment 5 and the example 1 is in the material ratio of the composite material in step S2:
S2: The E core 110 and the I core 120 are made of a composite material. The composite material, in mass percentage, composed of:
95% of iron-nickel-molybdenum powders;
4% of epoxy resin;
0.3% of silane coupling agent; and
0.7% of zinc stearate.

Wherein, the iron-nickel-molybdenum powders are composed of 10% of nickel, 10% of molybdenum, and the others are iron.

The structure of the duplex-winding coupling indictor in the embodiment is same as that in the example 1.

### Comparison Embodiment 6

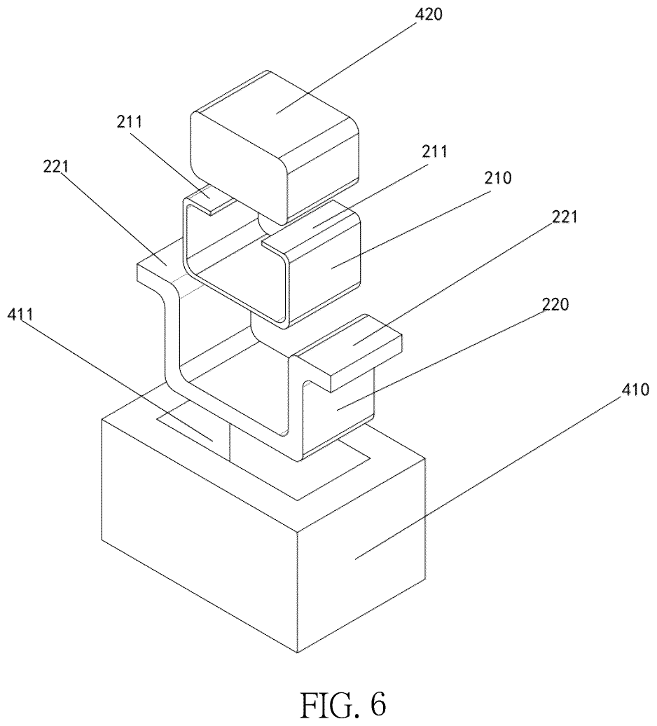

As shown in Table one and FIG. 6, comparing to the example 2, difference between the comparison embodiment 6 and the example 2 is to provide another duplex-winding coupling indictor and a preparing method for the same:
S1: making coils: An outer coil 220 is gained by a pressing process. An inner coil 210 is gained by a bending process. In practice, the outer coil 220 is made by a copper plate being pressed. The outer coil 220 is U-shaped with two ends bent outward to be served as leads 221 of the outer coil 220. The inner coil is made of flat copper wire with a polyurethanes insulating layer mounted around the outer surface of the wire bent three times. The inner coil 210 is C-shaped with two ends bent inward to be served as leads 211 of the inner coil 210.
S2: making magnetic body: A U core 410 and an I core 420 are made of a composite material, in mass percentage, composed of:
75% of iron-nickel-molybdenum powders;
25% of amorphous powders;
4% of epoxy resin;
0.3% of silane coupling agent; and
0.7% of zinc stearate.

Wherein, the iron-nickel-molybdenum powders are composed of 10% of nickel, 10% of molybdenum, and the others are iron.

Wherein the amorphous powders are composed of:
3.0% of Si;
4.0% of B;
1.0% of C;
0.03% of P;
0.01% of S.

The preparing method for the U core 410 and the I core 420 comprises the steps of:

The epoxy resin and the silane coupling agent are added into ethanol to gain a first mixer. The iron-nickel-molybdenum powders and the amorphous powders are added into the first mixer and are mixed evenly to make ethanol volatilize to gain a second mixer in a colloidal type. The second mixer is put into a granulator with a sieve having 100 meshes to granulate the second mixer into particles. The second mixer are baked under 45° C. for 2 hours and then sieved (a sieved with 100 meshes). The sieved particles are added with the zinc stearate and are then stirred at 100 r/min rotation speed for 0.5 hour to be mixed evenly and to gain a third mixer. The third mixed is put into molds. With cold processes, the U core 410 and the I core 420 are formed. The U core 410 has a chamber 411. The size of the chamber 411 correspond to the size of a combination of the outer coil 210, the I core 420 and the inner coil 220. The inner coil 210, I core 420 and the outer coil 220 are held in the chamber 411, and the outer coil 220 is arranged around the inner coil 210.

The I core 120 is a block, and the shape and the size of the I core 320 correspond to the shape and the size of a middle space of the inner core 210. Wherein, a pressure for the cold pressing is 3.5 T/cm², and the temperature for the cold pressing is at normal temperature. The amount of the added solvent is equal to 25% of the amount of the epoxy resin, the silane coupling agent, the iron-nickel-molybdenum powders, and the amorphous powders.
S3: assembling: The I core 420 is put into the middle space of the inner coil 210. The outer coil 220, the inner coil, and the I core 420 are put into the chamber 411 of the U core 410 to make the leads 211, 221 of the outer coil 220 and the inner coil 210 be exposed from the U core 410.
S4: hot pressing: The assembled U core 410, the outer coil 220, the inner coil 210, and the I core 420 is proceeded with a hot pressing process to form a formed element. The temperature for the hot pressing is 180° C., the pressure for the hot pressing is 5.5/cm², and the time for the hot pressing is 50 seconds.
D5: baking: The formed element is put into an oven, is gradiently temperature-increasing baked and is then gradiently temperature-decreasing baked. In practice,
a first section: temperature for baking being 80° C. and time for baking being 30 minutes;
a second section: temperature for baking being 100° C. and time for baking being 30 minutes;
a third section: temperature for baking being 120° C. and time for baking being 30 minutes;
a fourth section: temperature for baking being 140° C. and time for baking being 30 minutes;
a fifth section: temperature for baking being 180° C. and time for baking being 120 minutes;
a sixth section: temperature for baking being 140° C. and time for baking being 15 minutes;
a seventh section: temperature for baking being 120° C. and time for baking being 15 minutes; and
an eighth section: temperature for baking being 100° C. and time for baking being 15 minutes.
D6: rolling spray and peeling paint: the formed element is proceeded with rolling spray and peeling paint to gain an inductor. In the rolling spray, insulating paint is evenly coated on to the surface of the inductor. In the peeling paint, the paint on the portion on the leads 221, 211 of the outer coil 220 and the inner coil 210 exposed from the formed element are peeled off to make the copper plate and the copper wire be exposed from the surface of the inductor.
D7: surface treatment: Locations on the surface of the inductor with being peeled paint and two sides of the inductor being adjacent to the leads 221 of the outer coil 220 are respectively plated with a composite layer. The composite layer comprises a copper layer, a nickel layer, and a tin layer from outside to inside and a duplex-winding coupling inductor is gained. Wherein, the thickness of the copper layer is 3 μm, the thickness of the nickel layer is 2 μm, and the thickness of the tin layer is 7 μm. A side surface of the inductor plated with the composite layer is on a top surface to a position at ⅙ of a side surface of the leads 221 of the outer coil 220.

With reference to FIG. 6, he duplex-winding coupling inductor in accordance with the present invention comprises the U core 410, the I core 420, the inner coil 210, and the outer coil 220.

The U core 410 and the I core 120 are made of magnetic powders by a pressing process, actually by a cold pressing. The shape of the cores 410, 420 are cuboids. The chamber 411 are formed in the U core 410. The shape and the size of the chamber 411 correspond to the shape and the size of the combination of the inner coil 210, the I core 420, and the outer coil 220, such that the inner coil 210, the I core 420, and the outer coil 220 are embedded into the chamber 410. The outer coil 220 is arranged around the inner coil 210. The inner coil 210 is made of flat copper wire with a polyurethane insulating layer coated around the outer surface of the wire bent three times to form a C-shape. Two ends of the wire are bent inward to be severed as the leads 211 of the inner coil 210. The outer coil 220 is made of a flat copper plate is proceeded with a pressing process to form a U-shape. Two ends of the plate are bent outward to be severed as the leads 221 of the outer coil 220.

The I core 420 is a block. The shape and size of the I core 420 correspond to the shape and size of a middle space of the inner coil 210, such that the I core 420 can be held in the middle space of the inner coil 210. Accordingly, the I core 420, the inner coil 210, and the outer coil 220 are all assembled together and then are put into the U core 420, such that the combination is proceeded with a hot pressing process.

The leads 211, 221 of the inner coil 210 and the outer coil 220 exposed from the U core 410 are plated with a composite layer. Two sides of the inductor being adjacent to the leads 221 of the outer coil 220 are also plated with a composite layer. The composite layer comprises a copper layer, a nickel layer, and a tin layer from outside to inside. The other portions of the inductor are coated with an insulation paint layer.

Some performance tests are applied to the examples 1 to 3 and the comparison embodiments, the test method comprises steps of:

Induction and current tests: The samples are tested with an LCR tester with parameters: frequency: 1 MHz, biasing source (initial power up), tested value of induction and current.

Loss: tests with CHROMA 1810 tester with parameters 100 mT and frequency 100 KHz.

Voltage withstanding test: An inductor sample is provided with voltage 100V for 2 seconds to test the value of leakage current. The ideal value of the duplex-winding coupling indictor in accordance with the present invention is smaller than 2 mA. If the inductor is broken-down, the value of current is not shown.

The information for the performance tests is:

The value of induction: Based on different demands, the setting value (target value) of different inductors are different from each other, for instance, the setting value (target value) of the inductor in example 1 is 0.1 μH, the value of induction of the made inductor is more close to 0.1 μH, the value of induction is more stable.

Value of saturation current: The higher is the better.

Loss: The lower is the better.

Voltage withstanding test: The value of leakage current is the lower the better.

The test results are shown in Table one.

TABLE ONE
Formulas, parameters, and performance test results of the duplex-winding coupling indictors:

| | | | | Embodiment | Embodiment | Embodiment | Embodiment | Embodiment | Embodiment |
|---|---|---|---|---|---|---|---|---|---|
| Number | Example 1 | Example 2 | Example 3 | 1 | 2 | 3 | 4 | 5 | 6 |
| Formula 1 | FeNiM0 | FeNiM0 | FeNiM0 | FeNiM0 | FeNiM0 | FeNiM0 | FeNiM0 | FeNiM0 | FeNiM0 |
| | powders | powders | powders | powders | powders | powders | powders | powders | powders |
| | 70% | 75% | 73% | 80% | 85% | 75% | 75% | 95% | 75% |
| Formula 2 | amorphous | amorphous | amorphous | amorphous | amorphous | amorphous | amorphous | none | amorphous |
| | powders | powders | powders | powders | powders | powders | powders | | powders |
| | 25% | 20% | 23% | 16% | 11% | 20% | 20% | | 25% |
| Formula 3 | epoxy resin | epoxy resin | epoxy resin | epoxy resin | epoxy resin | epoxy resin | epoxy resin | epoxy resin | epoxy resin |
| | 4% | 4% | 3% | 3% | 3% | 4% | 4% | 4% | 4% |
| Formula 4 | coupling | coupling | coupling | coupling | coupling | coupling | coupling | coupling | coupling |
| | agent | agent | agent | agent | agent | agent | agent | agent | agent |
| | 0.3% | 0.3% | 0.3% | 0.3% | 0.3% | 0.3% | 0.3% | 0.3% | 0.3% |
| Formula 5 | zinc | zinc | zinc | zinc | zinc | zinc | zinc | zinc | zinc |
| | stearate | stearate | stearate | stearate | stearate | stearate | stearate | stearate | stearate |
| | 0.7% | 0.7% | 0.7% | 0.7% | 0.7% | 0.7% | 0.7% | 0.7% | 0.7% |
| Step S1 | As example | As example | As example | As example | As example | As example | As example | As example | As example |
| | 1 | 1 | 1 | 1 | 1 | 1 | 1 | 1 | 1 |
| Step S2cold | 3.5 T/cm² | 3.5 T/cm² | 3.5 T/cm² | 3.5 T/cm² | 3.5 T/cm² | 3.5 T/cm² | 3.5 T/cm² | 3.5 T/cm² | 3.5 T/cm² |
| pressing | 2 sec | 2 sec | 2 sec | 2 sec | 2 sec | 2 sec | 2 sec | 2 sec | 2 sec |
| pressure | | | | | | | | | |
| time | | | | | | | | | |
| Step S3 | As example | As example | As example | As example | As example | As example | As example | As example | As |
| assembling | 1 | 1 | 1 | 1 | 1 | 1 | 1 | 1 | embodiment |
| | | | | | | | | | 6 |
| Step S4 hot | 5.5 T/cm² | 5.5 T/cm² | 5.5 T/cm² | 5.5 T/cm² | 5.5 T/cm² | 5.5 T/cm² | 5.5 T/cm² | 5.5 T/cm² | 5.5 T/cm² |
| pressing | 180° | 180° | 180° | 180° | 180° | 180° | 180° | 180° | 180° |
| pressure | 50 sec | 50 sec | 50 sec | 50 sec | 50 sec | 50 sec | 50 sec | 50 sec | 50 sec |
| temperature | | | | | | | | | |
| time | | | | | | | | | |
| Step S5 | As example | As example | As example | As example | As example | As example | As example | As example | As example |
| baking | 1 | 1 | 1 | 1 | [symbol] 1 | 1 | 1 | 1 | 1 |
| stepS6 | As example | As example | As example | As example | As example | As example | As example | As example | As example |
| rolling spray | 1 | 1 | 1 | 1 | 1 | 1 | 1 | 1 | 1 |
| and peeling | | | | | | | | | |
| paint | | | | | | | | | |
| Step S7 | 3 μm | 3 μm | 3 μm | 3 μm | 3 μm | 3 μm | 3 μm | 3 μm | 3 μm |
| copper | 2 μm | 2 μm | 2 μm | 2 μm | 2 μm | 2 μm | 2 μm | 2 μm | 2 μm |
| nickel | 7 μm | 7 μm | 7 μm | 7 μm | 7 μm | 7 μm | 7 μm | 7 μm | 7 μm |
| tin | | | | | | | | | |
| induction L | 0.100 | 0.106 | 0.103 | 0.110 | 0.115 | 0.09 | 0.09 | 0.12 | 0.075 |
| (μH) | | | | | | | | | |
| Saturation | 80 | 75 | 78 | 70 | 65 | 70 | 85 | 60 | 80 |
| current | | | | | | | | | |
| (A) | | | | | | | | | |
| loss 100 mT | 950 mw | 1100 mw | 1035 mw | 1300 mw | 1400 mw | 1200 mw | 1200 mw | 1500 mw | 990 mw |
| Parameter 4 | 0.005 mA | 0.003 mA | 0.002 mA | 0.005 mA | 0.005 mA | 0.20 mA | 5 mA | 0.005 mA | 0.005 mA |
| leakage | | | | | | | | | |
| current | | | | | | | | | |

Steps in the preparing method, setting contrast of corresponding parameters

The features of the aforementioned examples and the embodiments can be arbitrarily combined. To be brief, all the combinations of the aforementioned examples and the embodiments are not described. However, the combination of the features are not contradict, they are all in the scope of the specification.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A composite material for preparing a duplex-winding coupling indictor, in mass percentage, composed of:
70% to 75% of iron-nickel-molybdenum powders;
20% to 25% of amorphous powders;
2% to 5% of epoxy resin;
0.3% to 0.5% of coupling agent; and
0.1% to 1.5% of zinc stearate, wherein
the iron-nickel-molybdenum powders are composed of 9% to 11% of nickel, 9% to 11% of molybdenum, and the others are iron.

2. The material as claimed in claim 1, wherein the amorphous powders, in mass percentage, are composed of:
2.0˜3.5% of Si;
2.0˜4.5% of B;
0.2-1.0% of C;
0.02-0.20% of P;
0.01-0.03% of S, and the others are iron.

3. A preparation method for a duplex-winding coupling inductor comprising steps as follows:
S1: making coils: an outer coil being gained by pressing process, an inner coil being gained by a bending process, the outer coil being U-shaped with two ends bent outward to be served as leads of the outer coil, and the inner coil being C-shaped with two ends bent inward to be served as leads of the inner coil;
S2: making magnetic body: making an E core and an I core by the composite material as claimed in claim 1, and comprising steps of:
adding the epoxy resin and the coupling agent into a solvent to gain a first mixer, adding the iron-nickel-molybdenum powders and the amorphous powders into the first mixer and mixing evenly to gain a second mixer, granulating the second mixer into particles, adding the zinc stearate into the particles and mixing evenly to gain a third mixer, putting the third mixer into molds to form the E core and the I core by cold pressing processes, wherein the E core has a holding recess for holding the outer coil and the inner coil inside and a block on a side of the E core, the I core has a cavity for holding the block on the E core, and a notch is defined in a bottom of the E core communicating with the holding recess;
S3: assembling: putting the outer coil and the inner coil made in S1 into the holding recess in the E core to make the leads of the outer coil and inner coil be exposed from the notch in the E core, and engaging the block on the E core with the cavity in the I core;
S4: hot pressing: hot pressing the assembled E core, the outer coil, the inner coil, and the I core to form a formed element;
D5: baking: baking the formed element;
D6: rolling spray and peeling paint: rolling spray and peeling paint the baked formed element to gain an inductor;
D7: surface treatment: locations on a surface of the inductor with being peeled paint and two sides of the inductor being adjacent to the leads of the outer coil being respectively plated with a composite layer, wherein the composite layer comprises a copper layer, a nickel layer, and a tin layer from outside to inside and a duplex-winding coupling inductor is gained.

4. The method as claimed in claim 3, wherein in the step S4, a temperature for the hot pressing is between 160° C. to 180° C., a pressure for the hot pressing is 5.0 to 6.0 T/cm², and/or a time for the hot pressing is 50 to 80 seconds.

5. The method as claimed in claim 3, wherein in the step S2, a pressure for the cold pressing is 3.5 to 4.0 T/cm², and/or a time for the cold pressing is 1 to 2 seconds.

6. The method as claimed in claim 3, wherein in the step S5, the baking comprises gradient temperature-increasing baking and radiantly temperature-decreasing baking and is composed of:
a first section: temperature for baking being 80±5° C. and time for baking being 30±3 minutes;
a second section: temperature for baking being 100±5° C. and time for baking being 30±3 minutes;
a third section: temperature for baking being 120±5° C. and time for baking being 30±3 minutes;
a fourth section: temperature for baking being 140±5° C. and time for baking being 30±3 minutes;
a fifth section: temperature for baking being 180±5° C. and time for baking being 120±3 minutes;
a sixth section: temperature for baking being 140±5° C. and time for baking being 15±3 minutes;
a seventh section: temperature for baking being 120±5° C. and time for baking being 15±3 minutes; and
an eighth section: temperature for baking being 100±5° C. and time for baking being 15±3 minutes.

7. The preparation method for a duplex-winding coupling inductor as claimed in claim 3, wherein in the step S2, the amorphous powders of the composite material, in mass percentage, are composed of:
2.0˜3.5% of Si;
2.0˜4.5% of B;
0.2-1.0% of C;
0.02-0.20% of P;
0.01-0.03% of S, and the others are iron.

8. The method as claimed in claim 7, wherein in the step S4, a temperature for the hot pressing is between 160° C. to 180° C., a pressure for the hot pressing is 5.0 to 6.0 T/cm², and/or a time for the hot pressing is 50 to 80 seconds.

9. The method as claimed in claim 7, wherein in the step S2, a pressure for the cold pressing is 3.5 to 4.0 T/cm², and/or a time for the cold pressing is 1 to 2 seconds.

10. The method as claimed in claim 7, wherein in the step S5, the baking comprises gradient temperature-increasing baking and radiantly temperature-decreasing baking and is composed of:
a first section: temperature for baking being 80±5° C. and time for baking being 30±3 minutes;
a second section: temperature for baking being 100±5° C. and time for baking being 30±3 minutes;
a third section: temperature for baking being 120±5° C. and time for baking being 30±3 minutes;
a fourth section: temperature for baking being 140±5° C. and time for baking being 30±3 minutes;
a fifth section: temperature for baking being 180±5° C. and time for baking being 120±3 minutes;
a sixth section: temperature for baking being 140±5° C. and time for baking being 15±3 minutes;
a seventh section: temperature for baking being 120±5° C. and time for baking being 15±3 minutes; and
an eighth section: temperature for baking being 100±5° C. and time for baking being 15±3 minutes.

11. A duplex-winding coupling inductor made by the method as claimed in claim 3.

12. The inductor as claimed in claim 11 comprising an formed element composed of the E coil, the outer coil, the inner coil, and the I core, the E coil has the holding recess and the block formed on the side of the E coil, the inner coil and the outer coil is held in the holding recess and the outer coil is arranged around the inner coil, the I core has a cavity defined in a side of the I core for being engaged with the block on the E core, the E core has the notch defined in the bottom of the E core and communicating with the holding recess, the leads of the outer coil and the inner coil are exposed from the notch in the E core, the leads of the outer coil and the inner coil exposed from the notch in the E core are respectively plating with a composite layer, and the composite layer comprises a copper layer, a nickel layer, and a tin layer from outside to inside.

13. The inductor as claimed in claim 12, wherein the holding recess is arranged around the block, a U-shaped protrusion is formed on a side of the E core, the holding recess is defined between the protrusion and the block, and the block is located inside the holding recess.

14. The inductor as claimed in claim 11, wherein a plug block is formed and protruding from a side of the I core, the cavity is defined in an inner surface of the plug block, a thickness of the inner coil and a thickness of the outer coil are all smaller than a depth of the holding recess, and the plug block is plugged into the holding recess.

15. The inductor as claimed in claim 11, wherein in the step S4, a temperature for the hot pressing is between 160° C. to 180° C., a pressure for the hot pressing is 5.0 to 6.0 T/cm², and/or a time for the hot pressing is 50 to 80 seconds.

16. The inductor as claimed in claim 11, wherein in the step S2, a pressure for the cold pressing is 3.5 to 4.0 T/cm², and/or a time for the cold pressing is 1 to 2 seconds.

17. The inductor as claimed in claim 11, wherein in the step S5, the baking comprises gradient temperature-increasing baking and gradient temperature-decreasing baking and is composed of:
a first section: temperature for baking being 80±5° C. and time for baking being 30±3 minutes;
a second section: temperature for baking being 100±5° C. and time for baking being 30±3 minutes;
a third section: temperature for baking being 120±5° C. and time for baking being 30±3 minutes;
a fourth section: temperature for baking being 140±5° C. and time for baking being 30±3 minutes;
a fifth section: temperature for baking being 180±5° C. and time for baking being 120±3 minutes;
a sixth section: temperature for baking being 140±5° C. and time for baking being 15±3 minutes;
a seventh section: temperature for baking being 120±5° C. and time for baking being 15±3 minutes; and
an eighth section: temperature for baking being 100±5° C. and time for baking being 15±3 minutes.

18. The duplex-winding coupling inductor as claimed in claim 11, wherein in the step S2, the amorphous powders of the composite material, in mass percentage, are composed of:
2.0˜3.5% of Si;
2.0˜4.5% of B;
0.2-1.0% of C;
0.02-0.20% of P;
0.01-0.03% of S, and the others are iron.

19. The inductor as claimed in claim 18 comprising an formed element composed of the E coil, the outer coil, the inner coil, and the I core, the E coil has the holding recess and the block formed on the side of the E coil, the inner coil and the outer coil is held in the holding recess and the outer coil is arranged around the inner coil, the I core has a cavity defined in a side of the I core for being engaged with the block on the E core, the E core has the notch defined in the bottom of the E core and communicating with the holding recess, the leads of the outer coil and the inner coil are exposed from the notch in the E core, the leads of the outer coil and the inner coil exposed from the notch in the E core are respectively plating with a composite layer, and the composite layer comprises a copper layer, a nickel layer, and a tin layer from outside to inside.

20. The inductor as claimed in claim 19, wherein the holding recess is arranged around the block, a U-shaped protrusion is formed on a side of the E core, the holding recess is defined between the protrusion and the block, and the block is located inside the holding recess.
